(19) United States
(12) Patent Application Publication
(10) Pub. No.: US 2003/0201676 A1
(43) Pub. Date: Oct. 30, 2003

(54) AC Adaptor with replaceable protection device

(76) Inventor: Carl Su, (US)

Correspondence Address: BROWDY AND NEIMARK, P.L.L.C., 624 NINTH STREET, NW, SUITE 300, WASHINGTON, DC, 20001-5303, US

(21) Appl. No.: 10/156,034

(22) Filed: May 29, 2002

(30) Foreign Application Priority Data
Apr. 25, 2002 (TW) 91205669

(51) Int. Cl. H02J 1/00

(52) U.S. Cl. 307/149

(57) ABSTRACT

An AC adaptor with a replaceable protection device is provided. The AC adaptor includes a main body at least having a power supply casing and a recessed socket on the power supply casing, and a protection device inserted into the socket. The protection device includes a casing, a plurality of metal pieces therein, and a resistor device connected the metal pieces. By changing different resistor devices, the resistance of the protection device changes accordingly; as this result, the AC adaptor is capable of providing different output voltages.

### BACKGROUND OF THE INVENTION

1. Field of the Invention

The present invention relates to an AC power adaptor. More particularly, the present invention relates to an AC power adaptor of providing different output voltages according to resistances of resistor devices inserted into the protection device for the AC power adaptor.

2. Description of the Prior Art

AC adapters are well known in the art. The AC adaptors are used in various electric equipments, such as the stereo system, charging set, earphone, printer, notebook, and soon, to convert the household AC current/voltage to a direct current/voltage in a suitable range, for example, 5 Volts or 12 Volts, for the sake of meeting the operation standard of these electric equipments.

Please refer to FIG. 1. FIG. 1 is a schematic diagram of a prior art AC adaptor 1a. As shown in FIG. 1, the prior art AC adaptor 1a includes a casing 11a, a core 12a, a DC plug 13a, and an AC plug 14a. The AC voltage from the AC plug 14a is converted to DC voltage by the circuit installed within the casing 11a. The AC adaptor 1a functions as a battery charger when it connects with a notebook. The shortcoming of such kind AC adaptor is that it provides only one DC voltage output.

Please refer to FIG. 2. FIG. 2 is a schematic diagram showing another prior art AC adaptor. As shown in FIG. 2, to provide different DC voltage outputs, an adjusting button 15a is installed on the casing 11a. An adjusting circuit (not shown) installed in the casing 11a is typically connected to the adjusting button 15a. The adjusting circuit is consisted of resistors. However, the adjusting circuit has to be soldered in the casing 11a in advance and is thus not easy to be implemented. Further, only up to three to five stages of voltage tuning can be provided by the adjusting button 15a. In a worst case, one can inadvertently adjust the adjusting button to an undesired stage, therefore causing severe damages to electric equipments connected. The worst scenario is the damaged electric equipment or the AC adaptor may explode to hurt users.

FIG. 3 is a schematic diagram of showing another prior art AC adaptor. As shown in FIG. 3, the AC adaptor 1a is used in vehicles. The AC adaptor 1a includes a vehicle power plug 14a′. While in use, the vehicle power plug 14a′ is inserted into a cigarette lighter socket provided in vehicles. However, the adjusting circuit is soldered in the vehicle power plug 14a′. Therefore, manufacturing this kind of AC adaptor 1a is costly and not easy.

### SUMMARY OF THE INVENTION

It is a primary object of the present invention is to provide an AC adaptor that uses replaceable protection devices to change the magnitude of the output voltage thereof. It is advantageous to use the present invention because the AC adaptor according to this invention is easy to make and has flexible operations and low production cost.

Another object of the present invention is to provide an AC adaptor that is suitable for city power and in vehicle-use.

Another object of the present invention is to provide an AC adaptor that can indicate the current power status.

According to the claimed invention, an AC adaptor with a changeable protection device is provided. The AC adaptor of this invention includes a main body at least having a power supply casing and a recessed socket on the power supply casing, and a protection device inserted into the socket. The protection device further includes a resistor device therein. By changing the resistor device, the resistance of the protection device changes accordingly, thus the AC adaptor provides different voltage outputs.

It is to be understood that both the forgoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

FIG. 1 is a schematic diagram of a prior art AC adaptor.

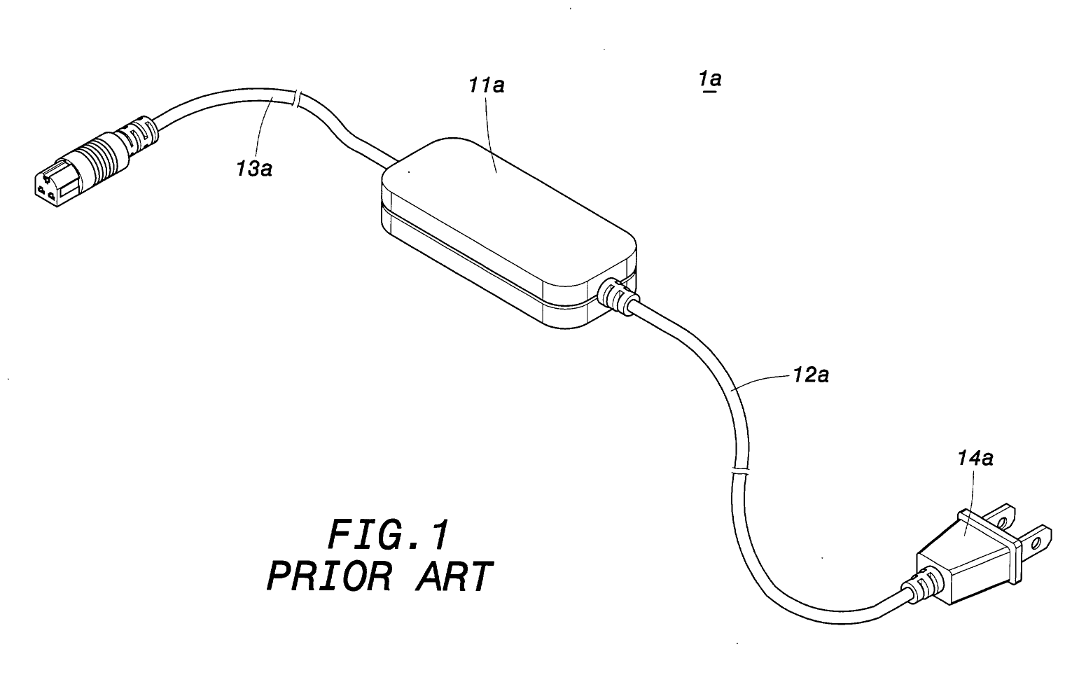

FIG. 2 is a schematic diagram showing another prior art AC adaptor.

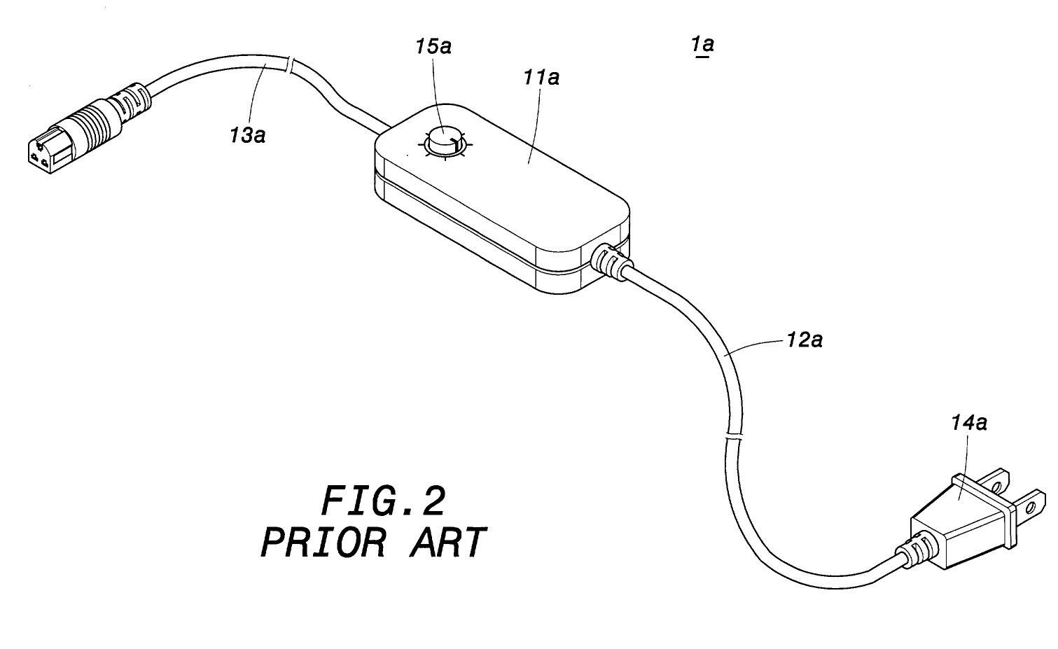

FIG. 3 is a schematic diagram showing an AC adaptor for vehicles according to the prior art.

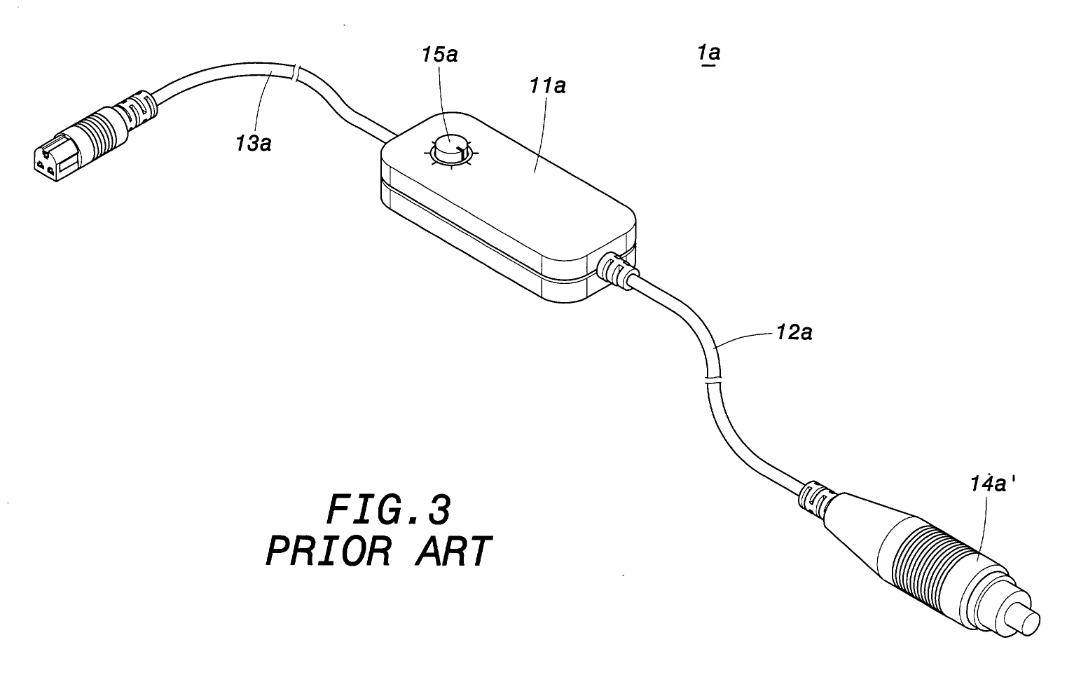

FIG. 4 is a schematic diagram of an AC adaptor according to the present invention.

FIG. 5 is a schematic diagram of the protection device of this invention.

FIG. 6 is a perspective schematic diagram after assembling the protection device.

FIG. 7 is a perspective schematic diagram of another preferred embodiment of the present invention.

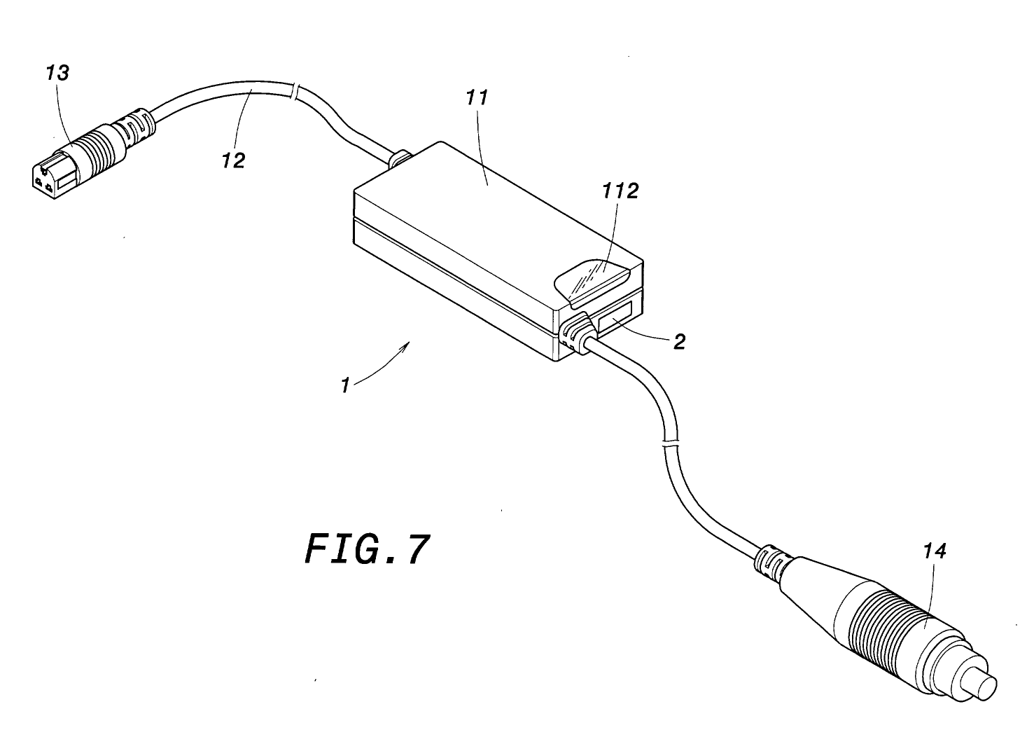

### DETAILED DESCRIPTION OF THE PREFERRED EMBODIMENT

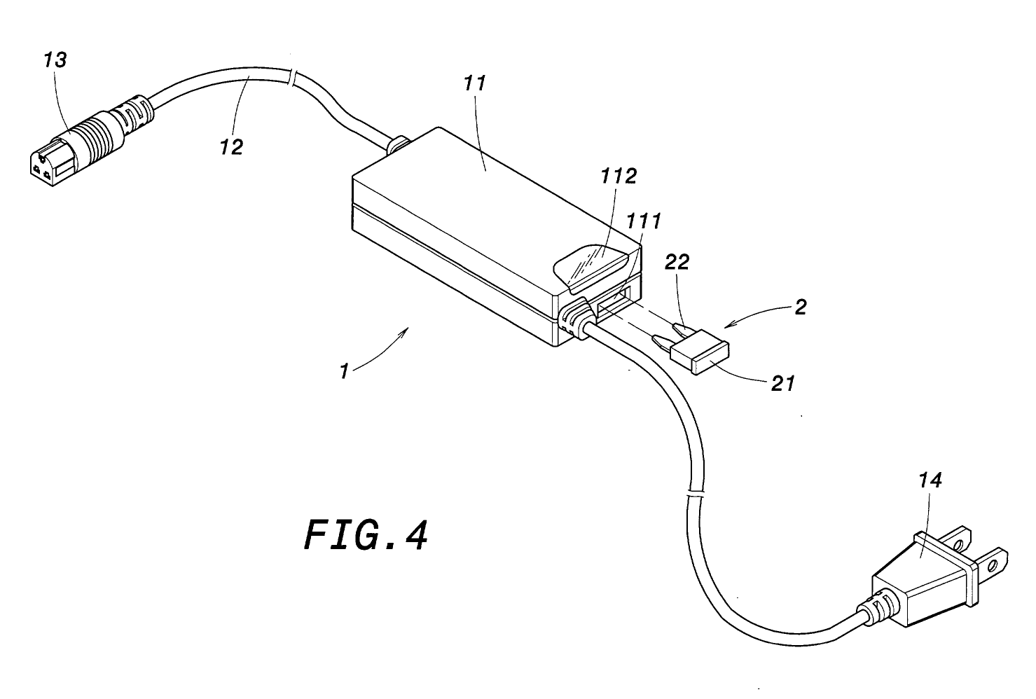

Please refer to FIG. 4 through FIG. 6. The present invention is directed to an AC adaptor. As shown in figures, the AC adaptor includes a main body 1 and a protection device 2. The main body 1 further includes a power supply casing 11, a DC input end 13, and an AC input end 14. Specifically, the DC input end 13 is a DC plug and the AC input end 14 is an AC plug or a city power plug. The main purpose of main body 1 is to plug the AC input end 14 into a city power socket thereby supplying AC current to the power supply casing 11. The AC current/voltage is then converted to the DC current/voltage by a converting circuit installed in the power supply casing 11. The relevant converting circuit is known in the art and the details of the converting circuit are thus omitted. Then, the DC current/voltage is supplied to an equipment connected to the DC input end 13. As illustrated, a recessed socket 111 is provided on one end of the casing 11 and is electrically connected to inner circuit in the casing 11.

The mentioned city power socket for the AC input end 14 may be equipped at houses or vehicles such as a train, plane, or tour bus.

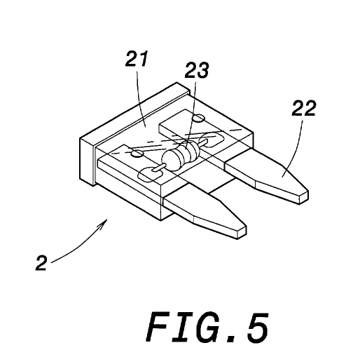

The protection device 2 is, as a whole, an electrically insulated casing 21. It can be made from plastic materials. Two conductive metal pieces 22 are installed in the protection device 2. These two conductive metal pieces 22 are connected to each other through a resistor device 23. One end of each of two conductive metal pieces 22 protrudes from one side of the insulated casing 21, as best seen in FIG. 5. The protruding parts of the conductive metal pieces 22 are inserted into the socket 111.

Accordingly, when a user inserts the protruding parts of the conductive metal pieces 22 of the protection device 2 into the socket 111, inner circuit of the main body 1 receives a corresponding output voltage in accordance with the interaction provided by a specific resistor device 23. Changing different protection devices 2 gets different voltage outputs. Hence, the present invention provides flexible and easy-to-use operations. It is obvious that the present invention solves the problems of prior art adaptors, for example, complicated structure, high production cost, and low flexibility. Further, it is more preferably to coat colors on the casing 21 and mark resistance values thereon to remind the users.

Moreover, a display circuit 112 is installed on the power supply casing 11. A light emitting diode (LED) is installed on the display circuit 112. When the power is on, the LED will indicate the current power status.

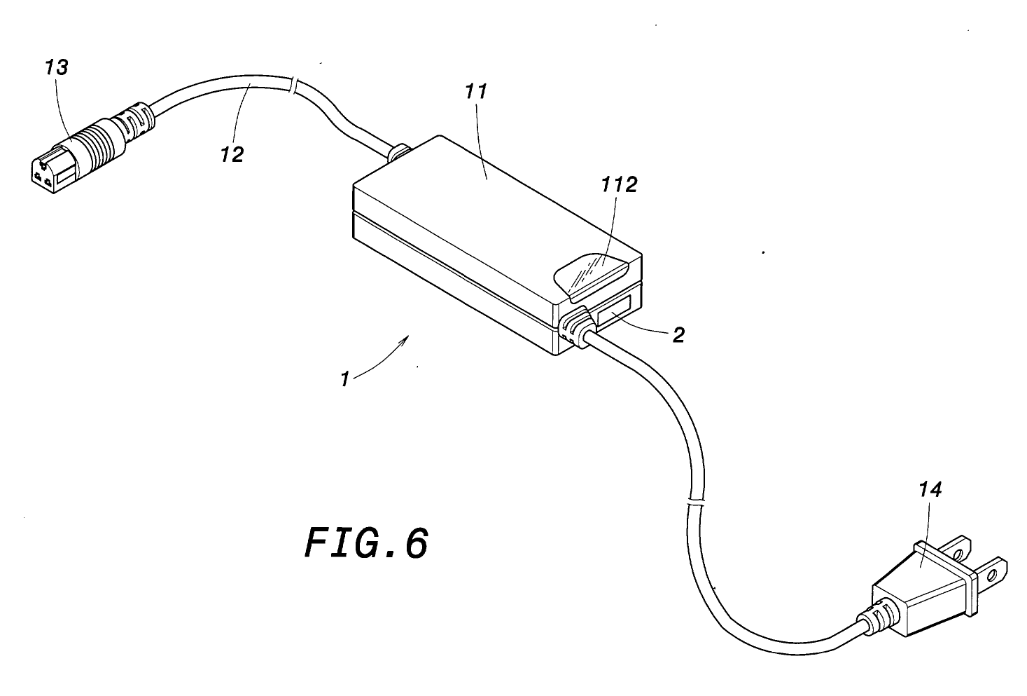

FIG. 6 is another preferred embodiment of the present invention. As shown in FIG. 6, the AC input end 14 is a vehicle power plug. While in use, the vehicle power plug is inserted into a cigarette lighter socket provided in the vehicle. By the configuration, the AC adaptor according to the present invention is hence suitable for various portable electric apparatuses such as a notebook, DVD player, PDA, or mobile communication equipments by simply changing protection devices for the sake of having different resistance values to have correspondingly different output voltages.

Those skilled in the art will readily observe that numerous modification and alterations of the device may be made while retaining the teachings of the invention. Accordingly, the above disclosure should be construed as limited only by the metes and bounds of the appended claims.

What is claimed is:

1. An AC adaptor, comprising:
a main body at least comprising a power supply casing and a recessed socket on the power supply casing; and
a protection device inserted into the recessed socket having a corresponding resistor device therein;
whereby the AC adaptor has different output voltages while replacing the resistor device with different resistances.

2. The AC adaptor of claim 1 wherein the main body is connected to an AC input end and a DC input end through a core.
The AC adaptor of claim 1 wherein the AC input end is a city power plug or a vehicle power converter.

4. The AC adaptor of claim 3 wherein the display circuit has light-emitting devices thereon.

5. The AC adaptor of claim 1 wherein the power supply casing comprises a display circuit.

6. The AC adaptor of claim 1 wherein the protection device comprises a casing, a plurality of metal pieces therein, and a resistor device connected to the metal pieces.

7. A protection device for an AC adaptor comprising a casing, a plurality of metal pieces therein, and a resistor device connecting the metal pieces thereof, wherein the metal pieces are inserted into a socket on the AC adaptor.
